(19) United States
(12) Patent Application Publication
(10) Pub. No.: US 2023/0350408 A1
(43) Pub. Date: Nov. 2, 2023

(54) INDEPENDENT ROBOT SAFETY SYSTEM USING A SAFETY RATED PLC

(71) Applicant: OMRON Corporation, Kyoto (JP)

(72) Inventors: Seth DUNTEN, Pleasanton, CA (US); Casey SCHULZ, Pleasanton, CA (US); Thomas KRIZNER, Pleasanton, CA (US); Deron JACKSON, Pleasanton, CA (US); James BRINK, Pleasanton, CA (US)

(21) Appl. No.: 17/997,816

(22) PCT Filed: May 11, 2021
(86) PCT No.: PCT/US2021/031840

§ 371 Date: Nov. 2, 2022

Related U.S. Application Data
(60) Provisional application No. 63/030,758, filed on May 27, 2020.

(51) Int. Cl. G05D 1/00; G05D 1/02

(52) U.S. Cl. CPC G05D 1/0055; G05D 1/024; G05D 1/0248; G05D 1/0272

(57) ABSTRACT

This application describes independent safety systems for robotic systems using a safety rated PLC. For example, a robotic safety system can include a first sensor that is operatively coupled to a drive assembly of a mobile robot. The first sensor can be configured to determine first rotation information of a wheel of the drive assembly. The system may further include a second sensor that is operatively coupled to the drive assembly. The second sensor may be configured to determine second rotation information of the wheel. The system can include a speed conversion module that is configured to receive the first and second rotation information at a first processing rate. The speed conversion module may also be configured to determine corresponding first and second speed information based on the first and second rotation information. The system can include a safety programmable logic controller (SPLC).

### CROSS-REFERENCE TO RELATED APPLICATION(S)

This application claims the benefit of U.S. Provisional Application No. 63/030,758, filed May 27, 2020, which is hereby incorporated by reference in its entirety.

### TECHNICAL FIELD

This disclosure generally relates to mobile robots, and in particular to improved safety systems for mobile robots.

### BACKGROUND

Mobile robots are used in many different industries to automate tasks typically performed by humans. Mobile robots can be autonomous or semi-autonomous and designed to operate within a specified area and complete, or assist humans in the completion of, industrial tasks. In one example, a mobile robot is a mobile robotic platform that can be used in a warehouse or other industrial setting to move and arrange materials through interaction with other cart accessories, robotic arms, conveyors and other robotic implementations. Each mobile robot can include its own autonomous navigation system, communication system, and drive components.

### SUMMARY

Disclosed herein are example methods and systems for safety systems for mobile robots. In one aspect, a robotic safety system includes first and second sensors each operatively coupled to a drive assembly of a mobile robot and configured to determine first and second rotation information, respectively, of a wheel of the drive assembly. The safety system further includes a speed conversion module that is configured to receive the first and second rotation information at a first processing rate. The speed conversion module is further configure to determine corresponding first and second speed information based on the first and second rotation information. The system further includes a safety programmable logic controller (SPLC) that is in communication with the speed conversion module and is configured to receive the first and second speed information from the speed conversion module at a second processing rate lower than the first processing rate. The SPLC is further configured to determine a risk parameter based on at least one of the first speed information or the second speed information and, in response to a determination that the risk parameter exceeds a threshold value, send instructions to reduce a flow of power to the drive assembly.

In another aspect, a method of improving safety of a mobile robot includes determining first rotation information of a wheel of a drive assembly using a first sensor. The method further includes determining second rotation information of the wheel using a second sensor. The method further includes determining error conditions by comparing the match between the first and second sensors. The method further includes determining corresponding first and second speed information based on the first and second rotation information. The method further includes determining a risk parameter based on at least one of the first speed information or the second speed information using a SPLC. The method further includes reducing a flow of power to the drive assembly in response to a determination that the risk parameter exceeds a threshold value.

The foregoing summary is illustrative only and is not intended to be limiting. Other aspects, features, and advantages of the systems, devices, and methods and/or other subject matter described in this application will become apparent in the teachings set forth below. The summary is provided to introduce a selection of some of the concepts of this disclosure. The summary is not intended to identify key or essential features of any subject matter described herein

### BRIEF DESCRIPTION OF THE DRAWINGS

Various examples are depicted in the accompanying drawings for illustrative purposes, and should in no way be interpreted as limiting the scope of the examples. Various features of different disclosed examples can be combined to form additional examples, which are part of this disclosure.

FIG. 1A shows an example mobile robot, according to some embodiments.

FIG. 1B shows a side view of the mobile robot of FIG. 1B.

FIG. 2 schematically shows an example safety system, according to some embodiments.

FIG. 3A schematically shows another example safety system, according to some embodiments.

FIG. 3B schematically shows an example speed conversion module, according to some embodiments.

FIG. 4 shows a flowchart representing an example method of improving safety of a mobile robot, according to certain embodiments.

### DETAILED DESCRIPTION

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

The present disclosure relates to improved safety systems for mobile robots using a safety programmable logic controller (SPLC or safety PLC). Previously, an SPLC was not used to monitor the speed of robotic parts as described herein. An SPLC provides numerous advantages for a safety system. For example, SPLCs employ redundancy checks to better ensure that safety protocols are not missed. However, in part due to the redundancy systems of the SPLCs, they may sample and/or process incoming data at a substantially slower rate than non-safety controllers. For example, certain traditional controllers may process data more than forty times faster than SPLCs. Because robots may be autonomous or semi-autonomous, safety concerns are of high importance. Inclusion of SPLCs in the speed monitoring and/or speed conversion systems can provide valuable redundancy and improve the safety of underlying drive assembly and/or speed conversion systems. Additionally, the SPLC provides a programmable method to safely include vehicle kinematic calculations (e.g., the relationship between wheel speeds and vehicle motion) as part of a risk parameter determination.

Described herein are safety systems that include an SPLC to capture the benefits of such elements. Such improved safety systems, as well as methods, are described herein. An example safety system can include first and second sensors each operatively coupled to a drive assembly of a mobile robot. The first sensor is configured to determine first rotation information of a wheel of the drive assembly, and the second sensor is configured to determine second rotation information of the wheel.

The safety system may also include a speed conversion module that receives the first and second rotation information, and determines first and second speed information based on the first and second rotation information. The system may include an SPLC that is in communication with the speed conversion module. The SPLC may receive the first and second speed information from the speed conversion module, and may determines a risk parameter based on at least one of the first speed information or the second speed information. In response to a determination that the risk parameter exceeds a threshold value, the SPLC may command adjusting an operation of the drive assembly, e.g., via sending instructions to reduce a flow of power to the drive assembly. This may include reducing power to the drive assembly and optionally engaging a braking system. Reference will now be made to the figures in providing additional details.

### Mobile Robots

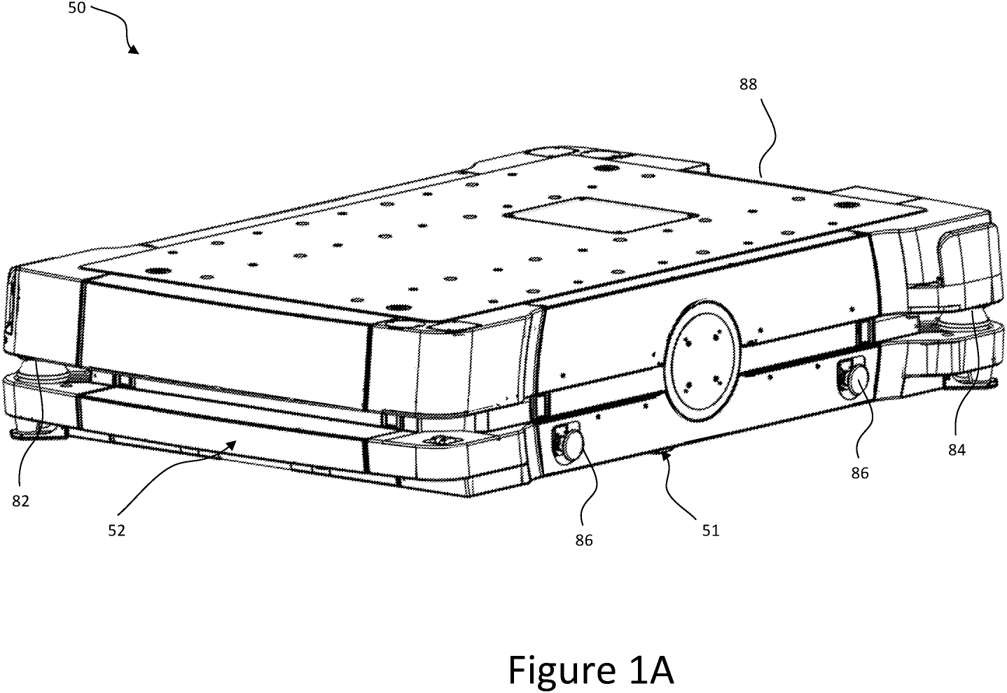

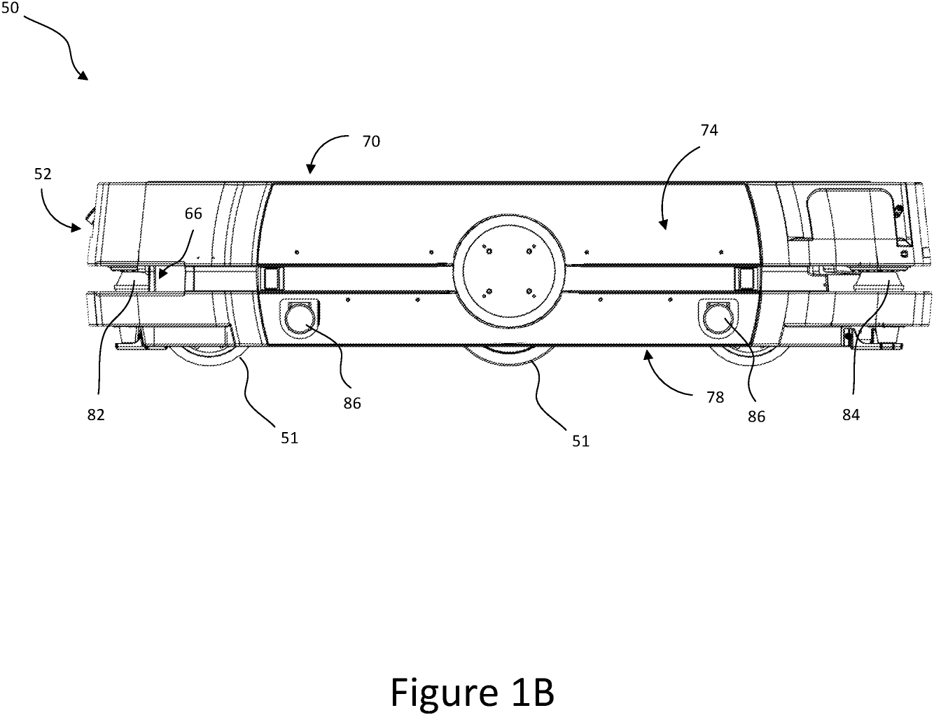

FIG. 1A shows an example mobile robot 50, according to some embodiments. The mobile robot 50 can include one or more wheels 51 and a front face 52. The mobile robot 50 can include a first distance sensor 82 and a second distance sensor 84. The mobile robot 50 can additionally or alternatively include one or more emergency stop buttons 86. The mobile robot 50 further includes a user interface 88, sometimes to referred to as an operator panel.

The first distance sensor 82 and second distance sensor 84 can be disposed at opposite ends of the mobile robot 50. As shown, the distance sensors 82, 84 are disposed in opposite corners of the mobile robot 50. The distance sensors 82, 84 can be disposed on the mobile robot 50 so as to increase the optical coverage of the distance sensors 82, 84 around the mobile robot 50. One or both of the distance sensors 82, 84 can be configured to capture optical data 360° around the respective sensor. In some embodiments, each of the distance sensors 82, 84 can obtain data 270° around the respective sensor and together the distance sensors 82, 84 can capture 360° around the mobile robot 50. Each distance sensor 82, 84 can be configured to capture data within a range of distances from the mobile robot 50. This range of distances may be modified by an SPLC (not shown) disposed in the mobile robot 50, as described in more detail below.

The emergency stop buttons 86 can be activated by a user in order to prevent damage to property or life. When any of the emergency stop buttons 86 is depressed, a signal can be sent to the SPLC to slow down or stop the mobile robot 50. Thus, the emergency stop buttons 86 serve as manual access to shutting down or slowing down the movement of the mobile robot 50.

FIG. 1B shows a side view of the mobile robot 50 of FIG. 1A. The mobile robot 50 can include an upper platform 70. The upper platform 70 can be a planer area, although any other suitable shape or structure can be used. The upper platform 70 can include locations for mounting other robotic implements onto the mobile robot 50. For example, the mobile robot 50 can engage with movable carts, tables, conveyors, robotic arms, and any other suitable application. The mobile robot 50 can include an outer shielding 74. The outer shielding 74 can include a plurality of sidewalls connected together to enclose or generally enclose safety controllers and systems, drive assemblies, speed conversion modules, navigation systems, communication systems, power systems, and/or other components used for operating the mobile robot 50.

The mobile robot 50 can be autonomous or semi-autonomous. As noted above, the mobile robot 50 can include a plurality of sensors for sensing the environment and/or mapping the robot’s surroundings. The sensors can include rangefinding and/or distance sensors, such as LIDAR and other optical-based sensors and/or other types of electro-sensitive protective equipment (ESPE), such as 3D safety vision. The mobile robot 50 can include a laser slit including a range finding or LIDAR-type laser contained therein, as indicated by the first distance sensor 82 and second distance sensor 84. The mobile robot 50 can include a user interface (not shown in FIG. 1B) for manually inputting instructions and/or receiving information from the mobile robot 50. In some embodiments, a control panel can additionally or alternatively be located on a side or under a plate or otherwise in an unexposed location on the mobile robot 50.

The mobile robot 50 can be generally oriented along a forward-reverse direction F-RV and along a left-right direction L-RT. The forward direction F can be along generally the forward motion of the robot. The reverse direction RV can be opposite the forward direction. The left-right direction L-RT can be orthogonal to the forward-reverse direction F-RV. The left-right direction L-RT and the forward-reverse direction F-RV can be coplanar, for example on a generally horizontal plane.

The upper platform 70, the outer shielding 74, and/or any other components of the mobile robot 50 can be mounted on a chassis. Various different components and structures can be mounted onto the chassis, depending on the purpose and design of the mobile robot 50. A support system 78 can include the one or more support wheels 51 (e.g., 2, 3, 4, or more wheels). The wheels 51 can be coupled with the chassis and/or drive assembly to move and/or brake the vehicle. Additionally wheels 51 can be undriven caster wheels. The wheels 51 can support a load on the chassis against a ground surface. In certain embodiments, the wheels 51 can include individual or combined suspension elements (e.g., springs and/or dampers). Accordingly, in some embodiments, the wheels 51 can move (e.g., up and down) to accommodate uneven terrain, for shock absorption, and for load distribution. In some embodiments, the wheels 51 can be fixed so that they do not move up and down, and the ground clearance height of the mobile robot 50 can be constant regardless of the weight or load of the mobile robot 50. In some examples, one or more of the wheels 51 may be undriven. In certain implementations, exactly two wheels 51 are driven.

The support system can include a drive assembly that can provide acceleration, braking, and/or steering of the mobile robot 50. In some embodiments, the drive assembly drives two wheels. These two wheels may be the wheels that guide the motion and directly of the mobile robot 50. For example, if both drive wheels rotate in a first direction, the mobile robot 50 can move forward; if both drive wheels move in a second direction, the robot can move in reverse; if the drive wheels move in opposite directions, or if only one of drive wheels moves, or if the drive wheels move at different speeds, the robot can turn. Braking can be performed by slowing the rotation of the drive wheels, by stopping rotation of the drive wheels, or by reversing direction of the drive wheels. Such braking can be controlled by one or more electronic controllers and/or a safety system. The drive assembly can be coupled (e.g., pivotably coupled) with the chassis. The drive assembly can be configured to engage with the ground surface through a suspension system. The drive assembly can be located at least partially beneath the outer shielding 74 of the mobile robot 50.

Many variations are possible. For example, a single drive assembly can be used, in some cases, which can move the robot forward and/or backward, and steering can be implemented using a separate steering system, such as one or more steering wheels that can turn left or right. In some embodiments, the mobile robot 50 can include 2, 3, or 4 drive assemblies. In certain alternative embodiments, the mobile robot 50 includes only driven wheels and no undriven support wheels. In some embodiments, the one or more drive assemblies can support at least some weight of the robot and/or payload. In some examples, the mobile robot 50 can include two drive wheels and two non-driven support wheels.

The mobile robot 50 can include one or more sensors for measuring motion of one or more of the wheels 51, such as the driven wheels. A sensor system may be used to detect and/or calculate rotation, position, direction, and/or other kinematic information from the movement of the wheels 51. In some examples, a plurality of sensors may be used to determine the kinematic information of each wheel. For example, each wheel may be associated with an optical sensor (e.g., an optical encoder) and a magnetic sensor (e.g., a bearing sensor) for determining the rotation of the wheel. Use of multiple sensors can be beneficial by providing a redundancy to the kinematic information so that if one system can for some reason not communicate its readings to a controller (e.g., malfunction, environmental shock, etc.), the other (or others) can provide the information. Additionally or alternatively, a loss of information from one sensor or a mismatch between redundant sensors may indicate a failure and possible safety issue. Thus, redundancy in the sensors can provide improved robustness and error detection. Motion of the mobile robot 50 may be slowed or stopped to prevent damage to life or property. Thus, a system failing may not mean that the controller becomes blind to the kinematic information and/or that the system becomes a danger. A further benefit of multiple sensors may be that the accuracy of the information may be improved because the controller may be able to rely on a greater amount of data in determining what the likely true values are. Examples of optical sensors include encoders (e.g., rotary, linear, absolute, incremental, etc.). Examples of magnetic sensors includes bearing sensors or other speed sensors. The mobile robot 50 can include other types of sensors, such as mechanical sensors, temperature sensors, distance sensors (e.g., rangefinders), and/or other sensors.

### Safety Systems

Robots, such as the mobile robots 50 described herein, may benefit from safety systems, such as those utilizing a safety programmable logic controller (SPLC or safety PLC). The mobile robot 50 includes an onboard power storage (e.g., one or more batteries) that can be manipulated by the SPLC in the event of a risk determination, such as those described herein.

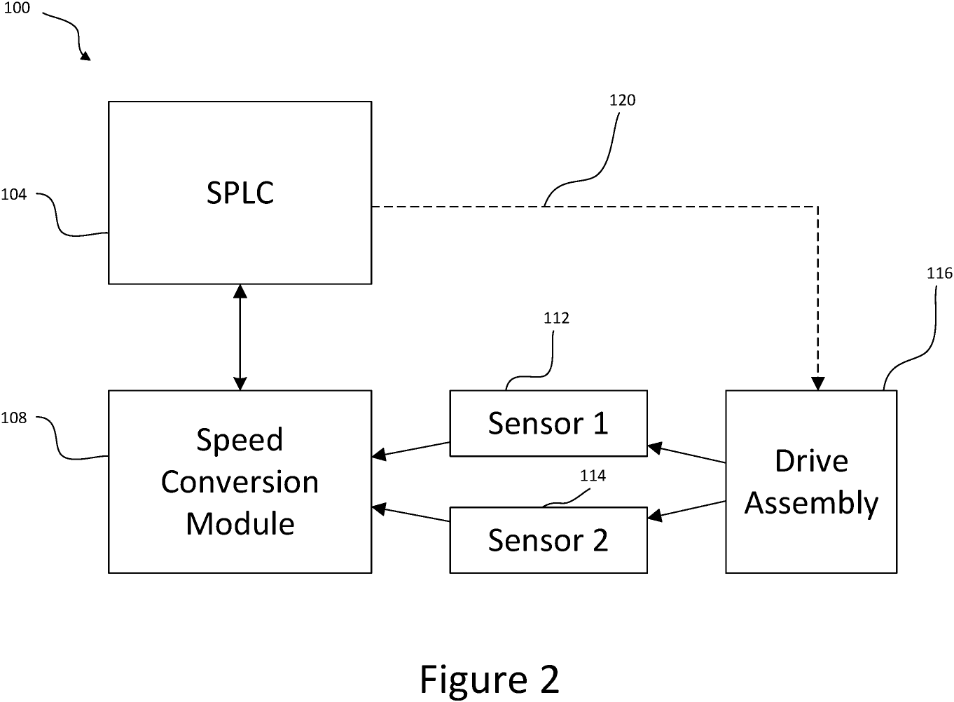

FIG. 2 schematically shows an example safety system 100, according to some embodiments. The safety system 100 can include an SPLC 104, a speed conversion module 108, a first sensor 112, a second sensor 114, and a drive assembly 116. The SPLC 104 can communicate with the drive assembly 116 via a communication line 120. The SPLC 104 can additionally or alternatively communicate directly with the speed conversion module 108. For example, the SPLC 104 may instruct the speed conversion module 108 which sensor to read. The speed conversion module 108 may communicate to the SPLC 104 which sensor is reading.

As discussed above, the drive assembly 116 can include one or more motors configured to drive the wheels 51 of the mobile robot 50. In some examples, one motor is associated with each of the driven wheels 51. Other variations are possible. The motor can drive the corresponding wheel 51 forward and/or backward, and the motor may drive the wheel 51 at different speeds. Additional speed conversion modules and/or sensors may be added for drive assemblies that sense rotation at multiple wheels and/or motors. For example, additional speed conversion modules and/or sensors may be used for respective additional wheels and/or motors (e.g., two drive motors with four sensors; two speed conversions; etc.).

The first sensor 112 and the second sensor 114 can each measure kinematic information associated with the motor. Kinematic information may include rotation information. Rotation information may include a number of rotations, a direction of rotation, an amount of time, etc. Each of the sensors 112, 114 can measure the same information of the same motor or portion of motor (e.g., motor shaft). For example, the sensors 112, 114 may both measure the number of rotations of a motor shaft of the drive assembly 116 over a period of time. This information may be passed to the speed conversion module 108. The information may be passed in real time and/or as the information is received and processed.

The sensors 112, 114 may obtain the rotation information using different methods. For example, the first sensor 112 may be an optical sensor and the second sensor 114 may be a magnetic sensor. Other types and/or combinations of sensors are possible. Examples of optical sensors include encoders (e.g., rotary, linear, absolute, incremental, etc.) or other optical sensors. Examples of magnetic sensors includes bearing sensors or other speed sensors. The safety system 100 can include other types of sensors, such as mechanical sensors, temperature sensors, distance sensors (e.g., rangefinders), and/or other sensors.

The speed conversion module 108 can receive the rotation information obtained by the sensors 112, 114 and convert the rotation information to speed information. The speed conversion module 108 may convert the rotation information from each of the sensors 112, 114 separately. For example, the speed conversion module 108 may convert first rotation information received from the first sensor 112 into first speed information, and the speed conversion module 108 may convert second rotation information received from the second sensor 114 into second speed information. In some examples, the speed conversion module 108 may combine the rotation information (e.g., average the information, take the highest/lowest information, etc.) before sending the speed information to the SPLC 104. The conversion of rotation information into speed information may include calculations based on additional information obtained (e.g., time, direction, etc.). The speed conversion module 108 may include two or more logic controllers, as discussed herein.

The speed conversion module 108 may be configured to process the rotation data at a rate faster than a processing rate of the SPLC 104. In some examples, the speed conversion module 108 is configured to process data more than 5 times, more than 10 times, more than 25 times, more than 50 times, more than 75 times, more than 100 times, or more than 200 times the processing rate of the SPLC 104. The processing rate of the speed conversion module 108 may be about 5 kHz, about 10 kHz, about 15 kHz, about 25 kHz, about 35 kHz, about 45 kHz, about 55 kHz, about 75 kHz, about 100 kHz, about 125 kHz, about 150 kHz, about 175 kHz, about 200 kHz, about 300 kHz, about 400 kHz, about 500 kHz, about 1 MHz, about 10 MHz, any value therein, or fall in a range having endpoints therein. In some examples, the processing rate of the speed conversion module 108 is about 400 kHz. Because the speed conversion module 108 can process data so much faster than the SPLC 104, the speed conversion module 108 may not substantially bottleneck or delay the flow of information through the safety system 100.

The SPLC 104 receives information from the speed conversion module 108. The SPLC 104 is a type of PLC, or programmable logic controller, configured to take in multiple sources of information and, based on that information, identify whether to reduce or stop the flow of power to the drive assembly 116. The SPLC 104 may employ redundancy checks using data obtained from the multiple sources of information (e.g., the first and second sensors 112, 114). This redundancy helps improve the monitor and management of safety protocols so that they are less likely to be missed or otherwise omitted.

In part due to the redundancy of the SPLC, it may be able to sample and/or process incoming data at a substantially slower rate than non-safety (e.g., generic) PLCs. The SPLC 104 may sample and/or process data from the speed conversion module 108 at a rate of between about 5 Hz and 500 Hz. The processing rate of the SPLC 104 may be about 5 Hz, about 10 Hz, about 15 Hz, about 25 Hz, about 35 Hz, about 45 Hz, about 55 Hz, about 75 Hz, about 100 Hz, about 125 Hz, about 150 Hz, about 175 Hz, about 200 Hz, about 300 Hz, about 400 Hz, about 500 Hz, any value therein, or fall in a range having endpoints therein. In some examples, the processing rate of the SPLC 104 is about 33 Hz. The SPLC 104 may include a Omron NX-SL3300 SPLC. Because the speed conversion module 108 can process data so much faster than the SPLC 104, the SPLC 104 is able to receive accurate and real-time speed information from the speed conversion module 108. The SPLC 104 may be configured to receive digital inputs and/or send digital outputs. In some embodiments, the SPLC 104 may be configured to receive analog inputs and/or send outputs. In some examples, the SPLC 104 is only able to receive digital inputs and/or send outputs.

The SPLC 104 can process the speed information obtained from the speed conversion module 108. The SPLC 104 may compare the first speed information (from the first sensor 112) with the second speed information (from the second sensor 114). The comparison may include determining whether both speed information indicates the same direction. If both speed information does not agree on the same direction, this is likely an indication that one or both of the sensors 112, 114 is not working properly. Such a discrepancy may cause the SPLC 104 to determine that a risk parameter of the safety system 100 has exceeded a threshold. In the event that the SPLC 104 determines that the risk parameter exceeds the threshold, the SPLC 104 can be configured to send instructions to the drive assembly 116 to reduce or stop a flow of power to the drive assembly 116.

The SPLC 104 may determine that the risk parameter has been exceeded from other outcomes. The SPLC 104 may compare a signal output of the sensors 112, 114. If a sensor is inoperable (e.g., not electrically connected), in some implementations the sensor will return an output that indicates its inoperability. In some examples, the SPLC 104 can determine from the output of inoperability alone that the risk parameter has exceeded the threshold.

Additionally or alternatively, the SPLC 104 may compare the speed information obtained from both sensors 112, 114 to determine a speed discrepancy. If the speed discrepancy exceeds a discrepancy threshold, the SPLC 104 may determine that the risk parameter has exceeded the threshold and may send shutoff instructions to the drive assembly 116. The discrepancy threshold may be about 5 mm/s, about 10 mm/s, about 15 mm/s, about 20 mm/s, about 25 mm/s, about 30 mm/s, about 35 mm/s, about 40 mm/s, about 45 mm/s, about 50 mm/s, about 55 mm/s, any value therein, or fall within a range having endpoints therein. In some examples, the discrepancy threshold is about 38 mm/s. Thus, a high discrepancy may be an indicator that the sensors 112, 114 are too far off in their readings, that the speed conversion module 108 is incorrect in its calculations, and/or that the drive assembly 116 is not functioning properly. If one or more of these situations might be accurate, the SPLC 104 may send a shutoff signal to the drive assembly 116 via the communication line 120. Thus, the SPLC 104 can prevent inadvertent danger or damage. The communication line 120 may be a wired or wireless (e.g., Bluetooth, Wi-Fi, or other communication means).

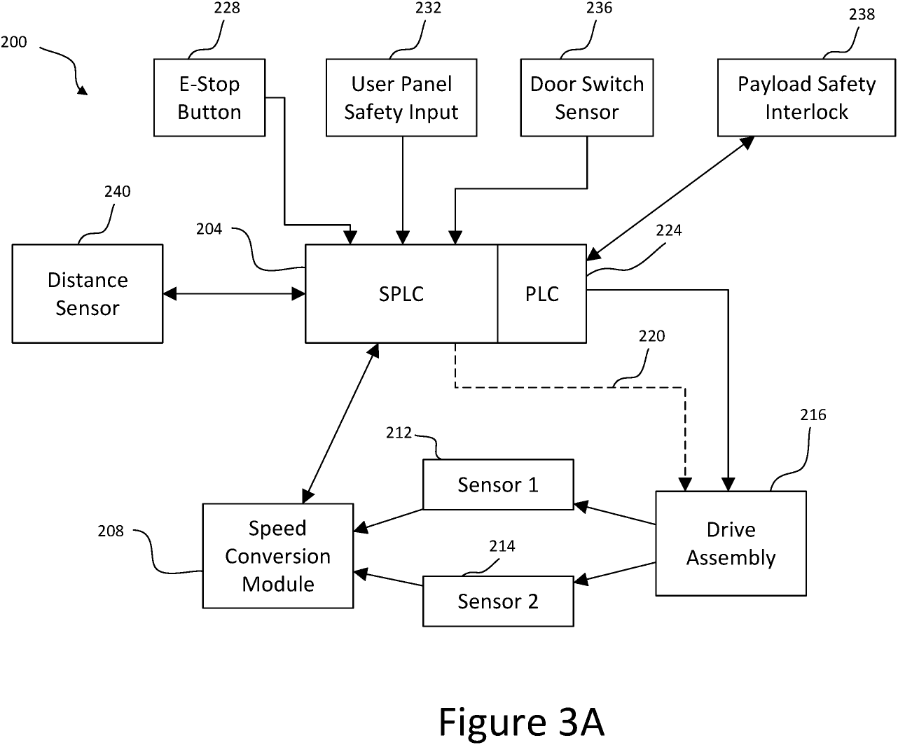

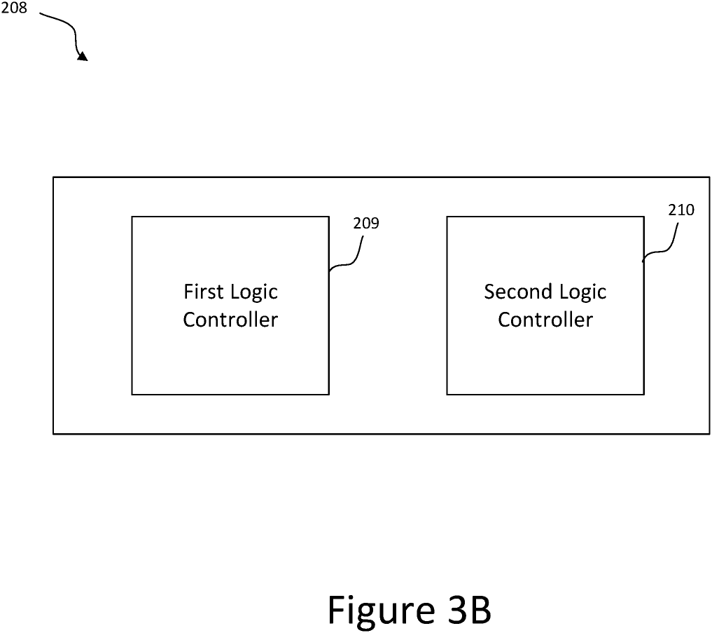

FIG. 3A schematically shows another example safety system 200, according to some embodiments. The safety system 200 includes an SPLC 204, a speed conversion module 208, a first sensor 212, a second sensor 214, a drive assembly 216, a communication line 220, a PLC 224, an emergency stop button 228, a user panel safety input 232, a door switch sensor 236, and a distance sensor 240. The safety system 200 may include elements having the same name as certain elements described above. For purposes of brevity and conciseness, elements having the same name may share one or more features of corresponding elements described above. Again, additional speed conversion modules 208, first sensor 212, and second sensor 214 may be added for drive assemblies that sense rotation at multiple wheels and/or motors.

The PLC 224 may be in electrical communication with the SPLC 204. In some examples, the SPLC 204 and the PLC 224 are disposed on the same circuit board. The PLC 224 may be configured to provide operation commands to one or more elements of the safety system 200. For example, the PLC 224 can be configured to provide drive commands (e.g., drive forward, drive backward, stop, accelerate, decelerate, etc.) to the drive assembly 216.

The SPLC 204 may be configured to receive emergency information from one or more sources, such as the emergency stop button 228, the user panel safety input 232, and/or the door switch sensor 236. As noted above, the mobile robot 50 may include one or more emergency stop buttons 86. The emergency stop button 228 of the safety system 200 may include one or more of the emergency stop buttons 86. Thus, when the emergency stop button 228 is depressed (e.g., manually), a stop signal may be passed to the SPLC 204. In response, the SPLC 204 may pass a shutoff signal to the drive assembly 216.

The SPLC 204 may receive an emergency signal from the user panel safety input 232. The user panel safety input 232 may include a signal generated by a user panel of the mobile robot. For example, the mobile robot may include a conveyor accessory with a plunger to stop an object (e.g., a pallet) from being conveyed off a platform connected to a protective stop input. The conveyor motor power may be controlled through the SPLC 204 connected to the user safety output. If the plunger falls (e.g., indicating that the object is no longer held in place securely) while the mobile robot is driving around, this may be an indication that the object could inadvertently fall off the conveyor accessory. Thus, it may be desirable to stop motion of the robot so that the pallet is not sent off the mobile robot. By contrast, if the mobile robot is already stopped and the plunger falls, this may be an indication that the mobile robot is doing a drop-off. Thus, power to the conveyor may be necessary to move the pallet but power to the mobile robot’s drive assembly 216 may be shutoff in order to prevent the mobile robot from driving away. This may prevent inadvertent injury or other damage.

In some examples, the mobile robot may include one or more door switches. The door switches may be tripped when a skin or covering (e.g., the outer shielding 74 of the mobile robot 50) is removed from the mobile robot. While one or more door switches are tripped (e.g., while a user is working on an interior of the mobile robot), the SPLC 204 may be configured to send and/or maintain power shutoff instructions to the drive assembly 216 and/or other electrical components of the mobile robot. Thus the SPLC 204 can provide further safety by preventing inadvertent shocks to users when, for example, contact is made with high-voltage elements while an interior of the mobile robot is accessible. In some embodiments, the safety system 200 can include a payload safety interlock 238. The payload safety interlock 238 can receive input from the PLC 224 and/or provide output thereto. The payload safety interlock 238 can allow interlock between motion of the mobile robot 50 and motion of a payload device. For example, another robot (e.g., a stationary robot with a mobile arm) may only be able move when the mobile robot 50 is stopped. An interlock output from the SPLC 204 to the payload safety interlock 238 can control such an interlock. Additionally or alternatively, the mobile robot 50 may be required to stop if the payload device is moving. As shown, the SPLC 204 can receive an input for this signal.

The SPLC 204 may be in communication with the distance sensor 240. The communication between the SPLC 204 and the distance sensor 204 may be bidirectional. For example, the distance sensor 240 can send a safe STOP signal to the SPLC 204 when a hazard is detected. In some embodiments, a STOP output may be provided instead of a safe STOP output (e.g., due to being out of range for a safe STOP signal). Additionally or alternatively, the SPLC 204 can send a search distance signal to the distance sensor 240. In some embodiments, the safety system 200 can include an array of sensors with difference ranges, which may indicate that a bi-directional communication between the SPLC 204 and the distance sensor 204 is not required. The distance sensor 240 may correspond to one or more of any distance sensor described herein (e.g., the first distance sensor 82 and/or the second distance sensor 84). The distance sensor 240 may include a LIDAR sensor or other rangefinder. The distance sensor 240 may be configured to search for potential hazards or dangers at a search distance and/or range of distances from the mobile robot. For example, the distance sensor 240 may search for objects within a range of 5 to 10 meters from the mobile robot. The search distance may be about 0.2 m, about 0.5 m, about 1 m, about 2 m, about 5 m, about 7 m, about 10 m, about 15 m, about 20 m, about 25 m, about 25 m, about 30 m, about 35 m, about 40 m, about 45 m, any value therein, or fall within any search range having endpoints therein.

If the SPLC 204 determines that a risk parameter has exceeded a threshold, then the SPLC 204 may send a signal to the distance sensor 240 to update the search distance and/or search range. Additionally or alternatively, if the SPLC 204 determines that the mobile robot is travelling at a different speed, the SPLC 204 may update the search distance and/or search range. For example, if the SPLC 204 determines that one of the sensors 212, 214 is not functioning properly, the SPLC 204 may send instructions to the drive assembly 216 to slow the speed of the mobile robot 50. Additionally or alternatively, the SPLC 204 may send a signal to the distance sensor 240 to reduce its search distance/range. As the mobile robot increases or decreases its speed, the SPLC 204 may instruct the distance sensor 240 to modify the search distance/range a corresponding amount. In some examples, the instructions from the SPLC 204 may be to modify another parameter of the search based on the received information from the speed conversion module 208. For example, the SPLC 204 may instruct the distance sensor 240 to search in a different direction and/or range of angles. Other variations are possible.

FIG. 3B schematically shows an example speed conversion module 208, according to some embodiments. The speed conversion module 208 may include two or more logic controllers. As shown, the speed conversion module 208 includes a first logic controller 209 and a second logic controller 210. The first logic controller 209 may be configured to process information (e.g., rotation information) received from the first sensor 212. Additionally or alternatively, the second logic controller 210 may be configured to process information from the second sensor 214. The first logic controller 209 and the second logic controller 210 may process corresponding data independent of each other. In this way, processed information may not be influenced by other information. One or both of the logic controllers 209, 210 may be configured to process incoming rotation data at processing rates of about 200 kHz, about 300 kHz, about 400 kHz or any other processing rate of speed conversion modules described herein. In one example, one or both of the logic controllers 209, 210 may include a complex programmable logic device (CPLD). In another example, one or both of the logic controllers 209, 210 may be part of a CPLD.

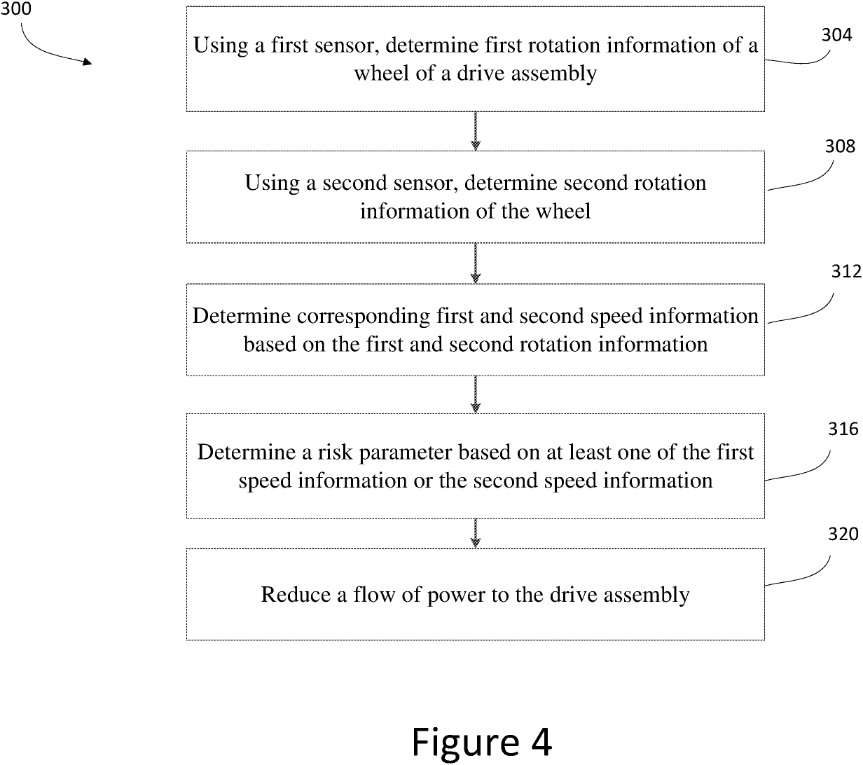

FIG. 4 shows a flowchart representing an example method 300 of improving safety of a mobile robot, according to certain embodiments. The method may be performed by one or more elements described herein. For example, steps of the method may be performed by a safety system (e.g., safety system 100, the safety system 200), a mobile robot (e.g., the mobile robot 50), and/or portions of one or both.

At block 304, the method 300 includes determining first rotation information of a wheel of a drive assembly using a first sensor. At block 308, the method 300 includes determining second rotation information of the wheel using a second sensor.

At block 312, the method 300 can include determining corresponding first and second speed information based on the first and second rotation information. At block 316, the method 300 includes determining a risk parameter based on at least one of the first speed information or the second speed information using an SPLC. In some embodiments, determining this risk parameter may include calculating motion kinematics of the vehicle from the wheel speeds. For example, the risk parameter may depend on the relative approach speed between vehicle and obstacle (e.g., difference between these speeds). A sensor (e.g., the sensor 240) could include a Doppler LIDAR sensor and/or may output object speed to the SPLC (e.g., the SPLC 204). This could allow for a more complex risk calculation involving both vehicle and object speed.

At block 320, the method 300 includes reducing a flow of power to the drive assembly in response to a determination that the risk parameter exceeds a threshold value.

The method 300 may include comparing the first and second speed information. In some examples, determining the risk parameter is based on the comparison of the first and second rotation information. In some examples, the first sensor comprises an optical encoder. Additionally or alternatively, the second sensor comprises a magnetic sensor.

The method 300 may further include identifying potential hazards within a first distance from the mobile robot using a distance sensor. The distance sensor may include LIDAR. The method 300 can include sending instructions to identify potential hazards within a second distance from the mobile robot different from the first distance in response to the determination of the risk parameter. Other variations are possible in light of the details discussed herein.

### Example Embodiments

A number of nonlimiting example embodiments are provided below that include certain features described above. These are provided by way of example only and should not be interpreted to limit the scope of the description above.

In a 1st embodiment, a robotic safety system comprises: a first sensor operatively coupled to a drive assembly of a mobile robot and configured to determine first rotation information of a wheel of the drive assembly; a second sensor operatively coupled to the drive assembly and configured to determine second rotation information of the wheel; a speed conversion module configured to: receive the first and second rotation information at a first processing rate; and determine corresponding first and second speed information based on the first and second rotation information; a safety programmable logic controller (SPLC) in communication with the speed conversion module and configured to: receive the first and second speed information from the speed conversion module at a second processing rate lower than the first processing rate; determine a risk parameter based on at least one of the first speed information or the second speed information; in response to a determination that the risk parameter exceeds a threshold value, send instructions to reduce a flow of power to the drive assembly.

In a 2nd embodiment, the robotic safety system of embodiment 1, wherein the SPLC is further configured to compare the first and second speed information.

In a 3rd embodiment, the robotic safety system of embodiment 2, wherein the SPLC is further configured to determine the risk parameter based on a comparison of the first and second rotation information.

In a 4th embodiment, the robotic safety system of any of embodiments 1-3, wherein the first sensor comprises an optical encoder.

In a 5th embodiment, the robotic safety system of any of embodiments 1-4, wherein the second sensor comprises a magnetic sensor.

In a 6th embodiment, the robotic safety system of any of embodiments 1-5, further comprising a distance sensor configured to identify potential hazards within a first distance from the mobile robot.

In a 7th embodiment, the robotic safety system of embodiment 6, wherein the distance sensor comprises LIDAR.

In a 8th embodiment, the robotic safety system of any of embodiments 6-7, wherein the SPLC is further configured to send, in response to the determination of the risk parameter, instructions to identify potential hazards within a second distance from the mobile robot different from the first distance.

In a 9th embodiment, the robotic safety system of any of embodiments 1-8, wherein the first sample rate is greater than about 10,000 Hz.

In a 10th embodiment, the robotic safety system of any of embodiments 1-9, wherein the second sample rate is lower than about 500 Hz.

In a 11th embodiment, the robotic safety system of any of embodiments 1-10, further comprising a second wheel and a second drive assembly.

In a 12th embodiment, the robotic safety system of embodiment 11, further comprising: a third sensor operatively coupled to the second drive assembly of the mobile robot and configured to determine first rotation information of the second wheel; and a fourth sensor operatively coupled to the second drive assembly and configured to determine second rotation information of the second wheel.

In a 13th embodiment, the robotic safety system of embodiment 12, further comprising a second SPLC in communication with the second speed conversion module and configured to: determine a second risk parameter based on at least one of the first speed information of the second wheel or the second speed information of the second wheel.

In a 14th embodiment, the robotic safety system of embodiment 13, wherein the second SPLC is further configured to: in response to a determination that the second risk parameter exceeds a second threshold value, send instructions to reduce a flow of power to the second drive assembly.

In a 15th embodiment, a method of improving safety of a mobile robot comprises: using a first sensor, determining first rotation information of a wheel of a drive assembly; using a second sensor, determining second rotation information of the wheel; determining corresponding first and second speed information based on the first and second rotation information; using a safety programmable logic controller (SPLC), determining a risk parameter based on at least one of the first speed information or the second speed information; and in response to a determination that the risk parameter exceeds a threshold value, reducing a flow of power to the drive assembly.

In a 16th embodiment, the method of embodiment 15, further comprising comparing the first and second speed information.

In a 17th embodiment, the method of embodiment 16, wherein determining the risk parameter is based on the comparison of the first and second rotation information.

In a 18th embodiment, the method of any of embodiments 15-17, wherein the first sensor comprises an optical encoder.

In a 19th embodiment, the method of any of embodiments 15-18, wherein the second sensor comprises a magnetic sensor.

In a 20th embodiment, the method of any of embodiments 15-19, further comprising identifying potential hazards within a first distance from the mobile robot using a distance sensor.

In a 21st embodiment, the method of embodiment 20, wherein the distance sensor comprises LIDAR.

In a 22nd embodiment, the method of any of embodiments 20-21, further comprising sending instructions to identify potential hazards within a second distance from the mobile robot different from the first distance in response to the determination of the risk parameter.

In a 23rd embodiment, the method of any of embodiments 15-22, further comprising: using a third sensor operatively coupled to a second drive assembly of the mobile robot to determine first rotation information of a second wheel of the second drive assembly; and using a fourth sensor operatively coupled to the second drive assembly to determine second rotation information of the second wheel.

In a 24th embodiment, the method of embodiment 23, further comprising: using a second SPLC in communication with the second speed conversion module to determine a second risk parameter based on at least one of the first speed information of the second wheel or the second speed information of the second wheel.

In a 25th embodiment, the method of embodiment 24, further comprising: in response to a determination that the second risk parameter exceeds a second threshold value, sending instructions to reduce a flow of power to the second drive assembly.

### Additional Considerations

Terms of orientation used herein, such as “top,” “bottom,” “proximal,” “distal,” “longitudinal,” “lateral,” and “end,” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain examples, as the context may dictate, the term “generally parallel” can refer to something that departs from exactly parallel by less than or equal to 20 degrees. All ranges are inclusive of endpoints.

Several illustrative examples of mobile robots and charging interfaces have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one example in this disclosure can be combined or used with (or instead of) any other portion of any of the steps, processes, structures, and/or devices disclosed or illustrated in a different example or flowchart. The examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In summary, various examples of mobile robots and related methods have been disclosed. This disclosure extends beyond the specifically disclosed examples to other alternative examples and/or other uses of the examples, as well as to certain modifications and equivalents thereof. Moreover, this disclosure expressly contemplates that various features and aspects of the disclosed examples can be combined with, or substituted for, one another. Accordingly, the scope of this disclosure should not be limited by the particular disclosed examples described above, but should be determined only by a fair reading of the claims. In some embodiments, the drive assembly(ies) and/or safety systems disclosed herein can be used in systems different than a mobile robot.

What is claimed is:

1. A robotic safety system comprising:
a first sensor operatively coupled to a drive assembly of a mobile robot and configured to determine first rotation information of a wheel of the drive assembly;
a second sensor operatively coupled to the drive assembly and configured to determine second rotation information of the wheel;
a speed conversion module configured to:
receive the first and second rotation information at a first processing rate; and
determine corresponding first and second speed information based on the first and second rotation information;
a safety programmable logic controller (SPLC) in communication with the speed conversion module and configured to:
receive the first and second speed information from the speed conversion module at a second processing rate lower than the first processing rate;
determine a risk parameter based on at least one of the first speed information or the second speed information;
in response to a determination that the risk parameter exceeds a threshold value, send instructions to reduce a flow of power to the drive assembly.

2. The robotic safety system of claim 1, wherein the SPLC is further configured to compare the first and second speed information.

3. The robotic safety system of claim 2, wherein the SPLC is further configured to determine the risk parameter based on a comparison of the first and second rotation information.

4. (canceled)

5. (canceled)

6. The robotic safety system of claim 1, further comprising a distance sensor configured to identify potential hazards within a first distance from the mobile robot.

7. The robotic safety system of claim 6, wherein the distance sensor comprises LIDAR.

8. The robotic safety system of claim 6, wherein the SPLC is further configured to send, in response to the determination of the risk parameter, instructions to identify potential hazards within a second distance from the mobile robot different from the first distance.

9. The robotic safety system of claim 1, wherein the first processing rate is greater than about 10,000 Hz.

10. The robotic safety system of claim 1, wherein the second processing rate is lower than about 500 Hz.

11. The robotic safety system of claim 1, further comprising a second wheel and a second drive assembly.

12. The robotic safety system of claim 11, further comprising:
a third sensor operatively coupled to the second drive assembly of the mobile robot and configured to determine first rotation information of the second wheel; and
a fourth sensor operatively coupled to the second drive assembly and configured to determine second rotation information of the second wheel.

13. The robotic safety system of claim 12, further comprising a second SPLC in communication with the second speed conversion module and configured to:
determine a second risk parameter based on at least one of the first speed information of the second wheel or the second speed information of the second wheel.

14. The robotic safety system of claim 13, wherein the second SPLC is further configured to:
in response to a determination that the second risk parameter exceeds a second threshold value, send instructions to reduce a flow of power to the second drive assembly.

15. A method of improving safety of a mobile robot, the method comprising:
using a first sensor, determining first rotation information of a wheel of a drive assembly;
using a second sensor, determining second rotation information of the wheel;
determining corresponding first and second speed information based on the first and second rotation information;
using a safety programmable logic controller (SPLC), determining a risk parameter based on at least one of the first speed information or the second speed information; and
in response to a determination that the risk parameter exceeds a threshold value, reducing a flow of power to the drive assembly.

16. The method of claim 15, further comprising comparing the first and second speed information.

17. The method of claim 16, wherein determining the risk parameter is based on the comparison of the first and second rotation information.

18. (canceled)

19. (canceled)

20. The method of claim 15, further comprising identifying potential hazards within a first distance from the mobile robot using a distance sensor.

21. (canceled)

22. The method of claim 20, further comprising sending instructions to identify potential hazards within a second distance from the mobile robot different from the first distance in response to the determination of the risk parameter.

23. The method of claim 15, further comprising:
using a third sensor operatively coupled to a second drive assembly of the mobile robot to determine first rotation information of a second wheel of the second drive assembly; and
using a fourth sensor operatively coupled to the second drive assembly to determine second rotation information of the second wheel.

24. The method of claim 23, further comprising:
using a second SPLC in communication with a second speed conversion module to determine a second risk parameter based on at least one of the first speed information of the second wheel or the second speed information of the second wheel.

25. The method of claim 24, further comprising:
in response to a determination that the second risk parameter exceeds a second threshold value, sending instructions to reduce a flow of power to the second drive assembly.
